(19) United States
(12) Patent Application Publication
(10) Pub. No.: US 2020/0246220 A1
(43) Pub. Date: Aug. 6, 2020

(54) Double-layer Medical Fluid Bag

(71) Applicant: Chung-Sing Lin, Tainan City (TW)

(72) Inventor: Chung-Sing Lin, Tainan City (TW)

(21) Appl. No.: 16/729,672

(22) Filed: Dec. 30, 2019

(30) Foreign Application Priority Data
Jan. 31, 2019 (TW) 108103738

(51) Int. Cl. A61J 1/12; A61J 1/14

(52) U.S. Cl. CPC A61J 1/12; A61J 1/1443; A61J 1/1406

(57) ABSTRACT

A double-layer medical fluid bag includes an inner wall, an outer wall, clean air filled between the inner and outer walls, and a piercing device installed between the inner and outer walls. When it is necessary to use a liquid medicine contained in the medical fluid bag, the piercing device is moved forward to pierce a plate to be pierced, so that the clean air can enter into the inner wall slowly to push the liquid medicine to flow downwardly to the outside. During the operation and use processes, the liquid medicine is completely isolated from outside air, so as to avoid the danger of having unknown outside air to enter into the medical fluid bag and endure the safety of using the medical fluid bag.

### BACKGROUND OF THE INVENTION

### Field of the Invention

The present invention relates to a medical fluid bag, and more particularly to a double-layer medical fluid bag capable of ensuring the safety of use.

### Description of the Related Art

In the medical environment, intravenous injection (drip) is the most frequently used route of drug administration, and patients are often seen lying on a patient bed or sitting in a wheelchair with a drip rack set nearby, and a drip fluid bag is hung onto the upper end of the drip rack, and an infusion tube is connected to the bottom of the drip fluid bag and provided for injecting a liquid medicine contained in a the drip fluid bag into a patient's body drop by drop to perform medical treatment. In the scene of injection drip, the drip fluid bag is referred to as a “medical fluid bag” of the present invention. In other blood donation operation, a blood donor's blood is drawn and then stored in a blood bag, and such “blood bag” is also one of the “medical fluid bags” of the invention. Therefore, bags used for storing a medical related liquid such as liquid medicine, blood, physiological saline, electrolyzed water that can be released and used in a medial related occasion or operation are included into the scope of the “medical fluid bag” of the present invention.

With reference to FIG. 1 for the use of a conventional medical fluid bag such as a drip fluid bag, the drip fluid bag 1 is hung onto a drip rack 2, wherein the drip fluid bag 1 has a single-layer tough flexible skin for filling in liquid medicines (such as drip medicine or physiological saline, etc.), a flexible block 11 such as a rubber block combined to the bottom of the drip fluid bag 1, a connector 12 inserted from the flexible block 11 into the drip fluid bag 1 through an tube opening of the connector 12, an infusion tubing 13 coupled to a rear end of the drip fluid bag 1, a vent needle 14 with a tiny diameter inserted into a wall of the drip fluid bag 1, such that the needle can enter into the space above the liquid medicine filled into the drip fluid bag 1 in order to balance the internal and external pressures of the drip fluid bag 1, and an infusion tube 15 coupled to the rear end of the infusion tubing 13 and passed downwardly to an injection needle (not shown in the figure) which is used for injecting the liquid medicine into a patient's arm.

The inventor of the present invention extremely concerns about medical work and medical operation environment and has profound experience about the necessity of inserting a vent needle 14 to balance the internal and external pressures of the drip fluid bag 1 when a conventional drip fluid bag 1 is used, in order to facilitate the operation of dripping the filled liquid medicine out of the drip fluid bag 1 slowly. However, the inventor of this invention believes that such arrangement requires further improvements, because medical fluid bag used in a medical operation environment such as a ward or an emergency room, especially the emergency room, which is an extremely busy, complicated, crowded environment with bacteria and viruses, so that after the vent needle 14 is unpacked, the vent needle 14 is actually and immediately situated in the air filled up with bacteria and viruses. In the medical operation environment, air filled with bacteria and viruses enters into the drip fluid bag 1 freely, and there is an unpredictable danger. Although modern medical treatment has already advanced, it is still often heard that some patients die suddenly while they are failing to respond to emergency treatment in hospitals, and such patients are having drips almost the whole day. The failure of emergency rescue still occurs under strict medical protection, and thus making people doubt about the risk of unknown infections caused by the insertion of the vent needle 14.

### SUMMARY OF THE INVENTION

In view of the aforementioned drawbacks of the conventional drip fluid bag, the inventor of the present invention based on years of experience in the related industry to conduct extensive research and experiment, and finally developed a double-layer medical fluid bag to overcome the drawbacks of the conventional medical fluid bag that requires the insertion of the vent needle 14 for passing air and has the danger of causing unknown infection. In the double-layer medical fluid bag of this invention, clean air is filled between an outer wall and an inner wall of the medical fluid bag, and a piercing device is installed between the outer wall and the inner wall. When it is necessary to use a liquid medicine contained in the medical fluid bag, the piercing device is moved forward to pierce a plate to be pierced, so that the clean air can enter into the inner wall slowly to push the liquid medicine to flow downwardly to the outside. Therefore, the double-layer medical fluid bag can completely avoid the danger of unknown outside air from entering into the medical fluid bag to ensure the safety of use.

It is a primary objective of the present invention to provide a double-layer medical fluid bag for avoiding the danger of unknown outside air from entering into the bag and ensuring the safety of use.

To achieve the above-mentioned objective, the present invention is particularly related to a double-layer medical fluid bag, comprising an inner wall, an outer wall and a piercing device, wherein a liquid medicine is filled into an interior space of the inner wall; the outer wall is spaced apart and surrounded around the exterior of the inner wall, and an interior space formed by the outer wall and the interval of the inner wall is provided for filling in clean air; the piercing device is installed between the outer wall and the inner wall; during operation, the piercing device is pressed at the outer surface of the outer wall, so that the piercing device moves forward to pierce the inner wall to allow the clean air to pass into the interior space of the inner wall, so as to produce a pushing effect to the liquid medicine.

According to the above-mentioned double-layer medical fluid bag, the piercing device comprises a column and an insert cavity, and the column is formed on an inner surface of the outer wall, and a cylindrical body of the column extends in a direction towards the inner wall and has a plurality of air holes formed on the cylindrical body of the column and communicated inwardly to a middle air passage, and a front end of the middle air passage is an air outlet with a tapered outer diameter; the insert cavity is formed on the inner wall and configured to be corresponsive to a position extendable and reachable by the air outlet of the column, and the insert cavity is formed into a concave shape in a direction away from the outer wall, and the inner wall of the insert cavity is a thin plate to be pierced, and an end of the air outlet of the column is pressed into the insert cavity.

According to the above-mentioned double-layer medical fluid bag, the cylindrical body of the column has a bump formed at a position with a small distance from the air outlet.

According to the above-mentioned double-layer medical fluid bag, the inner wall has a flexible block disposed at the bottom thereof, and provided for plugging in a nozzle end of a connector, and the rear end of the connector is coupled to an infusion tubing, and a rear end of the infusion tubing is coupled to an infusion tube and communicated downwardly to an injection needle.

With the aforementioned structure of the double-layer medical fluid bag of the present invention, the double-layer medical fluid bag can isolate outside air completely during operating and using processes of the medical fluid bag, so as to avoid the danger of unknown outside air from entering into the medical fluid bag and ensure the safety of use of the medical fluid bag.

### BRIEF DESCRIPTION OF THE DRAWINGS

FIG. 1 is a schematic view of a conventional medical fluid bag hung onto a drip rack;

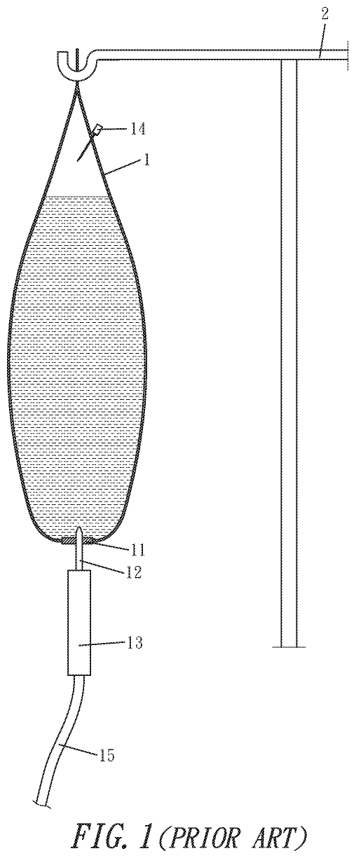

FIG. 2 is a schematic view of an embodiment of the present invention;

FIG. 3 is a blowup view of Section A of FIG. 2;

FIG. 4 is a schematic view of an embodiment of the present invention hung onto a drip rack;

FIG. 5 is a schematic view of an application of an embodiment of the present invention; and

FIG. 6 is a blowup view of Section B of FIG. 5.

### DETAILED DESCRIPTION OF THE PREFERRED EMBODIMENTS

The present invention will become clearer in light of the following detailed description of an illustrative embodiment of this invention described in connection with the drawings.

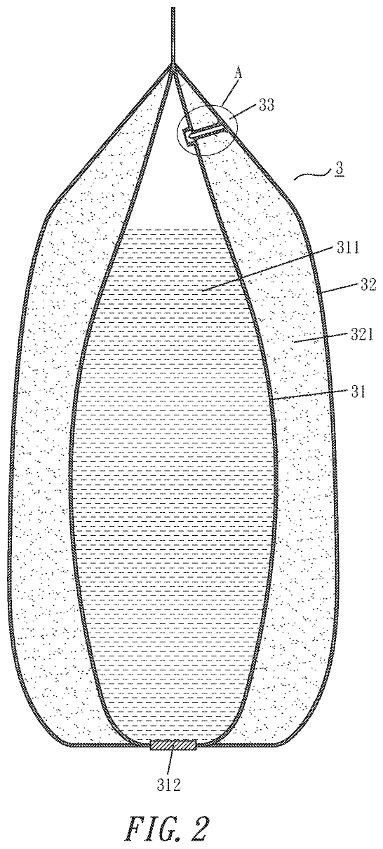

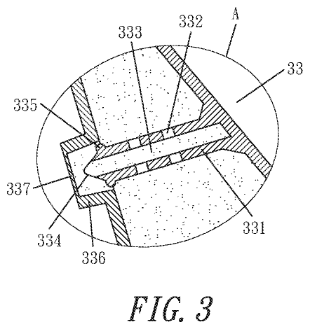

The present invention is directed to a medical fluid bag, which is a double-layer medical fluid bag 3 in accordance with an embodiment of the invention. In FIGS. 2 and 3, the medical fluid bag 3 comprises an inner wall 31, an outer wall 32 and a piercing device 33, wherein a liquid medicine 311 is filled into an interior space of the inner wall 31, and a flexible block 312 is disposed at the bottom of the inner wall 31; the outer wall 32 is spaced with an interval and surrounded around the exterior of the inner wall 31, and an interior space between the outer wall 32 and the inner wall 31 is provided for filling a clean air 321, and the air pressure is set according to actual requirements; the piercing device 33 comprises a column 331 and an insert cavity 336, and the column 331 is formed on an inner surface of the outer wall 32, and a cylindrical body of the column 331 extends in a direction towards the inner wall 31 and has a plurality of air holes 332 formed thereon and communicated inwardly to a middle air passage 333, and a front end of the middle air passage 333 is an air outlet 334 with a tapered outer diameter, and the cylindrical body of the column 331 has plurality of bumps 335 spaced with a small distance from the air outlet 334 and formed around the air outlet 334; the insert cavity 336 is formed on the inner wall 31 and configured to be corresponsive to a position extendable and reachable by the air outlet 334 of the column 331, and the insert cavity 336 is in a concave shape formed in a direction away from the outer wall 32, and the inner wall is a thin plate to be pierced 337, and the interior space of the formed insert cavity 336 is preferably partially pressed into an end of the air outlet 334 of the column 331.

The inner wall 31, the outer wall 32 and the piercing device 33 of the medical fluid bag 3 are all made of a tough and flexible material which is suitable for flexural deformation. Before exiting factory, the interior space of the inner wall 31 of the medical fluid bag 3 has been filled with the liquid medicine 311 of a predetermined volume and sealed in a water-tight and air-tight fashion. In the meantime, the interior space between the outer wall 32 and the inner wall 31 has been filled with the clean air 321 of a predetermined pressure which is set according to actual use. Now, the clean air 321 will enter into the middle air passage 333 through the air hole 332 and reach the air outlet 334, but it still cannot enter into the inner wall 31.

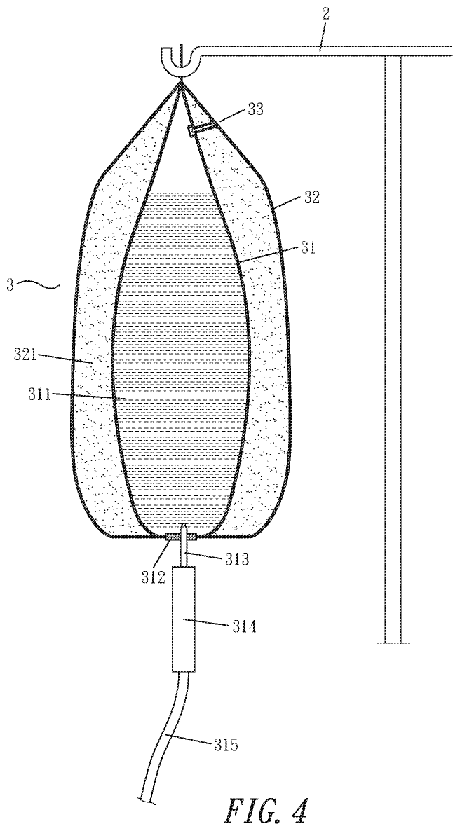

Before use in medical facilities, the whole medical fluid bag 3 is erected (mainly for the purpose of preventing the medical fluid bag 3 from being hit or knocked down, but it is not necessarily to be hung onto a high position) as shown in FIG. 4, wherein the whole medical fluid bag 3 is also hung onto a drip rack 2, and the flexible block 312 disposed at the bottom of the medical fluid bag 3 is provided for being plugged in by a nozzle end of a connector 313, and a rear end of the connector 313 is coupled to an infusion tubing 314, and a rear end of the infusion tubing 314 rear end is coupled to an infusion tube 315 and communicated downwardly to an injection needle (not shown in the figure), and then the injection needle is provided for injecting the liquid medicine 311 into a patient's arm.

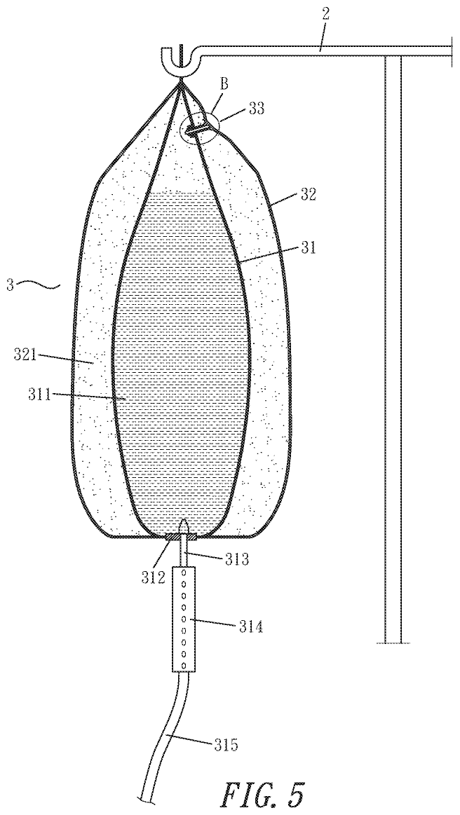

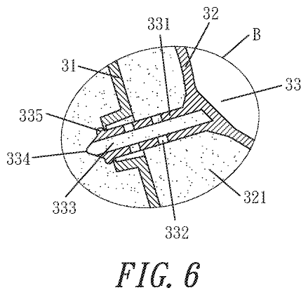

In FIGS. 5 and 6, an operator just needs to press the outer surface of the outer wall 32 in order to push the column 331 of the piercing device 33 to move forward, and then a front end of the air outlet 334 of the column 331 will move forward to pierce the plate to be pierced 337 of the insert cavity 336, so that the clean air 321 can pass into the interior space of the inner wall 31 and produce a pushing effect of the liquid medicine 311, and the liquid medicine 311 can flow downwardly to the outside. The downward flowing speed of the liquid medicine 311 can be regulated to a slow stable speed by a regulator (which is a prior art), so that there is no concern about a too-fast flow. When the front end of the air outlet 334 of the column 331 pierces the plate to be pierced 337 of the insert cavity 336, the column 331 will be pushed forward further to squeeze the bump 335 of the column 331 into the broken place of the plate to be pierced 337. After the front end of the air outlet 334 of the column 331 is released, the blocking by the bump 335 keeps the front end of the air outlet 334 to remain inside the inner wall 31 to ensure the smoothness of the clean air 321 passing into the inner wall 31.

In summation of the description above, the present invention mainly provides a double-layer medical fluid bag, wherein clean air is filled between the outer wall and the inner wall, and a piercing device is installed between the outer wall and the inner wall. When it is necessary to use the liquid medicine contained in the medical fluid bag, the piercing device is moved forward to pierce the plate to be pierced, so that the clean air can enter into the inner wall slowly to push the liquid medicine to flow downwardly to the outside. In the operating and using processes, the liquid medicine is completely isolated from the outside air to avoid the danger of entering unknown outside air into the medical fluid bag and ensure the safety of using the medical fluid bag.

While the invention is described in some detail hereinbelow with reference to certain illustrated embodiments, it is to be understood that there is no intent to limit it to those embodiments. On the contrary, the aim is to cover all modifications, alternatives and equivalents falling within the spirit and scope of the invention as defined by the appended claims.

What is claimed is:

1. A double-layer medical fluid bag, comprising an inner wall, an outer wall and a piercing device, wherein a liquid medicine is filled into an interior space of the inner wall; the outer wall is spaced apart and surrounded around the exterior of the inner wall, and an interior space formed by the outer wall and the interval of the inner wall is provided for filling in clean air; the piercing device is installed between the outer wall and the inner wall; during operation, the piercing device is pressed at the outer surface of the outer wall, so that the piercing device moves forward to pierce the inner wall to allow the clean air to pass into the interior space of the inner wall, so as to produce a pushing effect to the liquid medicine.

2. The double-layer medical fluid bag as claimed in claim 1, wherein the piercing device comprises a column and an insert cavity, and the column is formed on an inner surface of the outer wall, and a cylindrical body of the column extends in a direction towards the inner wall and has a plurality of air holes formed on the cylindrical body of the column and communicated inwardly to a middle air passage, and a front end of the middle air passage is an air outlet with a tapered outer diameter; the insert cavity is formed on the inner wall and configured to be corresponsive to a position extendable and reachable by the air outlet of the column, and the insert cavity is formed into a concave shape in a direction away from the outer wall, and the inner wall of the insert cavity is a thin plate to be pierced, and an end of the air outlet of the column is pressed into the insert cavity.

3. The double-layer medical fluid bag as claimed in claim 2, wherein the cylindrical body of the column has a bump formed at a position with a small distance from the air outlet.

4. The double-layer medical fluid bag as claimed in claim 1, wherein the inner wall has a flexible block disposed at the bottom thereof, and provided for plugging in a nozzle end of a connector, and the rear end of the connector is coupled to an infusion tubing, and a rear end of the infusion tubing is coupled to an infusion tube and communicated downwardly to an injection needle.
